(19) United States
(12) Patent Application Publication
(10) Pub. No.: US 2007/0275587 A1
(43) Pub. Date: Nov. 29, 2007

(54) Gripping mechanism of bridge board

(75) Inventors: Lin-Wei Chang, Taipei (TW); Yung-Chin Hsu, Taipei (TW); Chi-Kang Hsieh, Taipei (TW); Ya Ping Hsu, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/523,314

(22) Filed: Sep. 18, 2006

(30) Foreign Application Priority Data
May 29, 2006 (TW) 095209265

(51) Int. Cl. H01R 13/62

(52) U.S. Cl. 439/327

(57) ABSTRACT

A gripping mechanism for securing in position a bridge board electrically connecting two circuit boards is disclosed. An electrical connecting portion is installed on both of the circuit boards, for electrical connection with the bridge board which has a terminal at both ends. The gripping mechanism includes a gripping component formed by a metal wire bent and pivotally installed at one end of the electrical connecting portion. The gripping component is rotatable so as to better secure in position the bridge board to the circuit boards after the terminals of the bridge board are respectively inserted into the electrical connecting portions of the circuit boards.

### BACKGROUND OF THE INVENTION

1. Field of the Invention

The present invention relates to a gripping mechanism of a bridge board, and more particularly, to a gripping mechanism for better securing in position a bridge board to a circuit board.

2. Description of the Prior Art

Normally, electronic devices are connected to each other by a signal transmission wire. Transmitting signals between two circuit boards inside an electronic device by means of a flat cable is simple and convenient but imposes restriction on functionalities. However, the flat cable cannot play the role alone, if the signals transmitted between the two circuit boards work well only when transformed or decoded; in such a situation, signal conversion has to be achieved by a signal conversion apparatus or a decoder, and the signal conversion apparatus or the decoder has to be installed between the two circuit boards, and thus not only does the electronic device become bulky, but the electronic device has an untidy layout due to the presence of the flat cable.

Put forth to overcome the drawbacks of the conventional method for connecting two circuit boards by a flat cable is a known technique illustrated with FIG. 1 and described as follows. Two circuit boards 12a and 12b are connected to each other by a bridge board 11 which comprises a circuit. The bridge board 11 has an A/D or D/A signal conversion function, a decoding function, or additional electrical functions, thus overcoming the drawback of transmitting signals by a flat cable. The bridge board 11 has goldfingers, such as terminals 110, at both ends. Correspondingly, the circuit boards 12a and 12b are equipped with electrical connecting portions 13a and 13b. Hence, the terminals 110 at both ends of the bridge board 11 are inserted into the electrical connecting portions 13a and 13b of the circuit boards 12a and 12b. The bridge board 11 is electrically connected to circuit boards 12a and 12b respectively so as to achieve electrical connection therebetween. Also, the bridge board 11 is configured for signal conversion or decoding so as to allow the circuit boards 12a and 12b to transmit signals to each other, thus bringing the functionalities of the two electrically connected circuit boards 12a and 12b into full play.

The bridge board 11 is secured in position to the circuit boards 12a and 12b only when the terminals 110 at both ends of the bridge board 11 are inserted into the electrical connecting portions 13a and 13b of the circuit boards 12a and 12b, or, to be specific, only by means of a friction resulting from insertion of the electrical connecting portions 13a and 13b into the terminals 110. However, in a vibration test or a free-fall test, the bridge board 11 is likely to get detached from one of the circuit boards 12a and 12b or become poorly electrically connected to the circuit boards 12a and 12b and thereby end up with a breakdown.

Accordingly, an issue that needs an urgent solution is related to endeavors to provide a mechanism for improving the conventional method for installing a bridge board on circuit boards so as to prevent the vibration test or the free-fall test from causing poor electrical connection.

### SUMMARY OF THE INVENTION

In order to solve the aforesaid drawbacks of the prior art, it is a primary objective of the present invention to provide a gripping mechanism whereby a bridge board is better secured in position to circuit boards.

Another objective of the present invention is to provide a gripping mechanism whereby a bridge board is prevented from loosening or getting detached from a circuit board after being secured in position to the circuit board.

Yet another objective of the present invention is to provide a gripping mechanism whereby a bridge board is free from poor contact after being secured in position to circuit boards.

In order to achieve the above and other objectives, the present invention discloses a gripping mechanism for securing in position and electrically connecting a bridge board having a terminal at both ends to two circuit boards having an electrical connecting portion each. The gripping mechanism comprises a gripping component disposed at an end of the electrical connecting portion and configured to better secure in position the bridge board to the circuit boards.

At least one end of the electrical connecting portion is disposed with a vertical portion. The vertical portion comprises an insertion slit for guiding the terminal of the bridge board such that the terminal of the bridge board is inserted into the electrical connecting portion. The vertical portion comprises two opposing surfaces in which a positioning groove is disposed. The positioning groove is upright. The gripping component is formed by a metal wire bent and pivotally disposed beneath the positioning groove such that the gripping component is moved and slided into the positioning groove for positioning. After the bridge board is secured in position to the circuit boards, the gripping component is rotated and pressed against the edge of the top of the bridge board such that the bridge board is pressed against the electrical connecting portion.

The vertical portion is disposed with a through-hole beneath the positioning groove. The gripping component is provided with a gap. The gap enables the gripping component to be inserted into the through-hole, thus pivotally installing the gripping component in the electrical connecting portion. The gripping component comprises a press portion for moving the gripping component. In so doing, the gripping component is rotated and pressed against the edge of the top of the bridge board, or conversely the bridge board is released.

With the bridge board being inserted into the electrical connecting portion and the gripping components being pressed against the edge of the top of the bridge board, the bridge board is better secured in position to the circuit boards, thus preventing the bridge board from poor connection or detachment which may otherwise occur due to vibration or a fall.

The present invention discloses a gripping mechanism for gripping a bridge board so as to prevent poor electrical connection between the bridge board and circuit boards, such as poor contact and detachment, which may otherwise occur due to vibration or a fall. Hence, the present invention is more efficient than the prior art.

### BRIEF DESCRIPTION OF THE DRAWINGS

FIG. 1 (PRIOR ART) is a schematic view: of a conventional bridge board configured for electrical connection with two circuit boards;

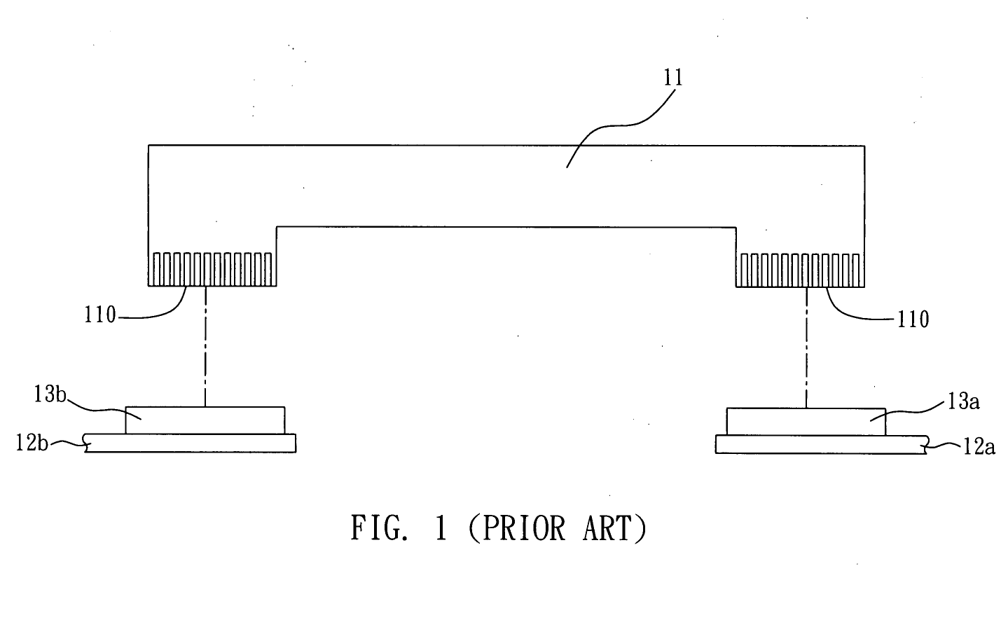

FIG. 2 is an exploded perspective view showing how to better secure in position a bridge board to circuit boards by a gripping mechanism in accordance with the present invention; and

FIG. 3 is an exploded perspective view of a gripping mechanism of a bridge board in accordance with the present invention.

### DETAILED DESCRIPTION OF THE EMBODIMENTS

The present invention is herein illustrated with a specific embodiment, so that one skilled in the pertinent art can easily understand other advantages and effects of the present invention from the disclosure of the invention.

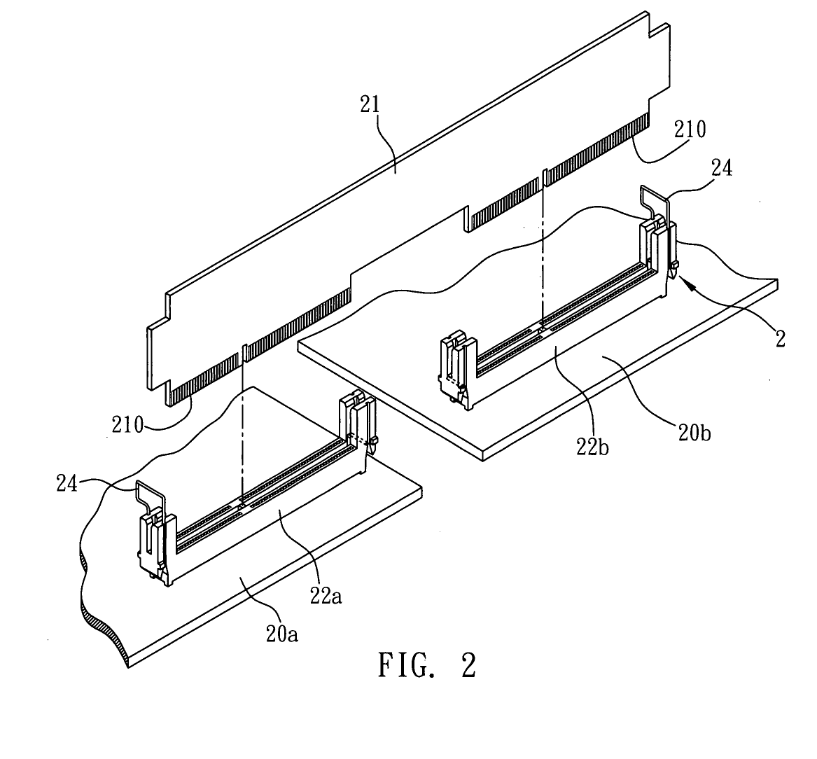

Referring to FIG. 2, a gripping mechanism 2 of a bridge board of the present invention secures in position a bridge board 21 electrically connecting two circuit boards 20a and 20b. The circuit boards 20a and 20b are disposed with electrical connecting portions 22a and 22b respectively for electrical connection with the bridge board 21 having a terminal 210 at both ends.

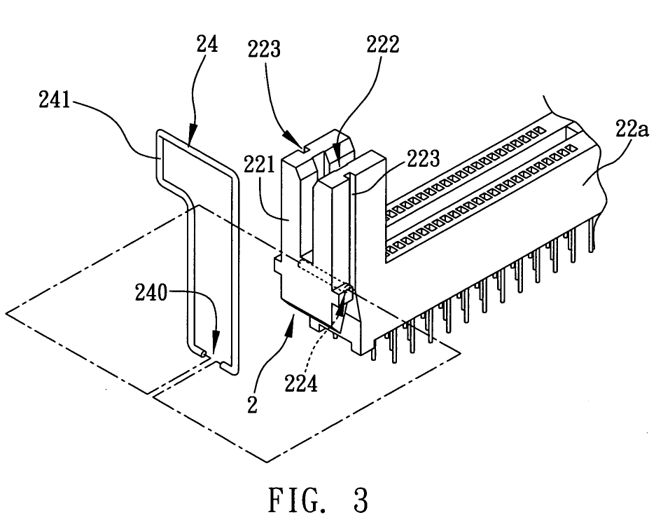

Referring to FIG. 3, at least one end of the electrical connecting portion 22a (or 22b) is disposed with a vertical portion 221. The vertical portion 221 is disposed with an insertion slit 222 for guiding the terminal 210 of the bridge board 21 such that the terminal 210 of the bridge board 21 is inserted into the electrical connecting portion 22a. The vertical portion 221 comprises two opposing surfaces in which a positioning groove 223 is disposed. The positioning groove 223 is upright. Disposed beneath the positioning groove 223 is a through-hole 224. Inserted into the through-hole 224 is a gripping component 24 formed by bending a metal wire. The gripping component 24 comprises a gap 240 whereby the gripping component 24 is inserted into the through-hole 224, thus pivotally disposing the gripping component 24 beneath the positioning groove 223. The gripping component 24 comprises a press portion 241 for moving the gripping component 24.

The terminals 210 at both ends of the bridge board 21 are inserted into the electrical connecting portions 22a and 22b respectively so as to electrically connect the bridge board 21 to the circuit boards 20a and 20b. Then, with the press portion 241, the gripping component 24 is rotated and moved such that both ends of the gripping component 24 are slid into the positioning groove 223 for positioning. An upper portion of the gripping component 24 abuts on an edge of a top of the bridge board 21 such that the bridge board 21 is pressed against the electrical connecting portions 22a and 22b. In so doing, the bridge board 21 is better secured in position to the circuit boards 20a and 20b.

The present invention discloses a gripping mechanism of a bridge board. Terminals of the bridge board are inserted into electrical connecting portions of circuit boards. The gripping mechanism comprises a gripping component which is rotated and pressed against an edge of a top of the bridge board. Accordingly, a bridge board is better secured in position to circuit boards, thus preventing the bridge board from poor contact or detachment which may otherwise occur to any vibrating or falling bridge board during a vibration test or a free-fall test or while in use.

The foregoing specific embodiment is only illustrative of the features and functions of the present invention but is not intended to restrict the scope of the present invention. It is apparent to those skilled in the art that all equivalent modifications and variations made in the foregoing embodiment according to the spirit and principle in the disclosure of the present invention should fall within the scope of the appended claims.

What is claimed is:

1. A gripping mechanism of a bridge board, wherein the bridge board is configured to secure in position and electrically connect two circuit boards each having an electrical connecting portion for electrical connection with the bridge board, the electrical connecting portion being disposed with the gripping mechanism positionally corresponding to any of two terminals of the bridge board, the gripping mechanism comprising a gripping component disposed at an end of the electrical connecting portion and configured to secure in position the bridge board to the circuit boards.

2. The gripping mechanism of claim 1, wherein the electrical connecting portion comprises a positioning groove disposed in two opposing surfaces at the end of the electrical connecting portion, the positioning groove being upright, the end of the electrical connecting portion being disposed with the gripping component.

3. The gripping mechanism of claim 2, wherein the gripping component is formed by a metal wire bent and pivotally installed in the positioning groove of the electrical connecting portion, such that the gripping component is moved, and both ends of the gripping component are slid into the positioning groove for positioning.

4. The gripping mechanism of claim 3, wherein the electrical connecting portion comprises a vertical portion, the vertical portion further comprising a through-hole beneath the positioning groove, the gripping component having a gap whereby the gripping component is inserted into the through-hole and thereby is pivotally disposed in the electrical connecting portion.

5. The gripping mechanism of claim 3, wherein the gripping component comprises a press portion for moving the gripping component.
